(19) United States
(12) Patent Application Publication
(10) Pub. No.: US 2020/0269167 A1
(43) Pub. Date: Aug. 27, 2020

(54) FLUID FILTER

(71) Applicant: Caterpillar Inc., Deerfield, IL (US)

(72) Inventors: Philip Carl Spengler, Washington, IL (US); Bart A. Fisher, Metamora, IL (US)

(73) Assignee: Caterpillar Inc., Deerfield, IL (US)

(21) Appl. No.: 16/286,150

(22) Filed: Feb. 26, 2019

(51) Int. Cl. B01D 29/90; B01D 29/21

(52) U.S. Cl. CPC B01D 29/902; B01D 2201/302; B01D 2201/291; B01D 29/21

(57) ABSTRACT

A filter element may include and endcap, filter media extending from the endcap, and a sleeve disposed at least partially surrounding the filter media. The sleeve may include an outer surface including a plurality of protrusions and a plurality of openings may be formed through the sleeve. The protrusions may direct fluid to be filtered by the filter media along a path that allows particulates to exit the fluid prior to contacting the filter media.

### TECHNICAL FIELD

This disclosure relates generally to a filter assembly, and more specifically to a filter assembly for removing contaminants from fluids.

### BACKGROUND

Many systems utilize fluids, e.g., fuel, oil, hydraulic fluids, lubricants, or the like, in their operation. These systems also may utilize fluid filtering techniques to promote effective and efficient operation. By way of non-limiting example, many types of engines, including internal combustion engines, gasoline engines, diesel engines, or the like, operate more effectively with clean fuel. Specifically, fuel contaminants, if not removed from fuel circulating through an engine, may lead to undesirable operation of the engine and/or may increase the wear rate of engine components. For instance, effective removal of contaminants in the fuel system of an internal combustion engine may be particularly important. Such fuel systems may include fuel injectors and/or other components manufactured to exacting tolerances and/or shapes to improve engine efficiency and/or to reduce undesirable exhaust emissions. Water and/or other contaminants, such as particulates, that are not removed from fuel may interfere with and/or damage proper operation of these components.

Fuel filtration systems serve to remove contaminants from fuel. For example, some conventional fuel filtration systems may include a fuel filter. Fuel filters are often provided to remove water and large particulate matter. However, in many conventional systems, filter media is exposed to fuel to be filtered, and while the filter media may be effective at removing large contaminants, such large contaminants can often become lodged in the filter media. For example, some conventional filter media include pleats, and larger particulate matter can become lodged between adjacent pleats, thereby degrading effectiveness of the filter media and potentially damaging the filter media. Other systems and fluids also may benefit from filtering.

An example gas filtration system is described in U.S. Pat. No. 3,917,458 (hereinafter referred to as the '458 reference). In particular, the '458 reference describes fluidized filtration screens offset relative to each other and containing a particulate filtration matter therebetween. More specifically, the structure described in the '458 reference includes a fluidized filter formed of a series of stacked annular louver sets consisting of an annular outlet louver inclined downwardly and inwardly and a smaller diameter inlet louver inclined downwardly and outwardly. The outlet and inlet louvers define a small annular gap and the particulate matter is captured between the louvers, e.g., in the gap. The '458 reference teaches a complex arrangement that acts as a dry scrubber for high velocity large flow gas streams, and does not, however, disclose details related to a fluid filter assembly for use with fluids typically associated with an engine or other, similar applications. The '458 reference also does not disclose components for use with conventional filter media and/or in conventional applications. As a result, the techniques described in the '458 reference may be inapposite to certain fluid filtering applications described herein.

Example embodiments of the present disclosure are directed toward improving the state of the art.

### SUMMARY

In an aspect of the present disclosure, a filter element includes an endcap, filter media extending from the endcap in a longitudinal direction, and a sleeve at least partly surrounding the filter media. The sleeve may include a protrusion on an outer surface of the sleeve and an opening extending through the sleeve. The protrusion may include an inclined surface angled relative to the longitudinal axis to direct fluid flowing along the protrusion away from the longitudinal axis. At least a portion of the opening may be relatively closer to the endcap than at least a portion of the protrusion.

In another aspect of the present disclosure, a filter assembly includes an endcap, filter media disposed to extend form the endcap in a longitudinal direction; and a sleeve disposed at least partially surrounding the filter media. The sleeve may include an outer surface including a plurality of protrusions and a plurality of openings. At least a portion of a first protrusion of the plurality of protrusions may be disposed relatively farther from the endcap than a first opening of the plurality of openings to force fluid travelling generally along the outer surface in a direction toward the endcap radially outwardly from the first opening.

In yet another aspect of the present disclosure, a filter assembly includes a housing, an endplate, and a filter element. The housing may include a housing sidewall extending in a longitudinal direction between a closed end and an opposite, open end such that the housing sidewall and the closed end define an interior volume. The endplate may be disposed in the open end and may include an inlet and an outlet. The filter element may be at least partially disposed in the interior volume. The filter element may include an endcap spaced from the endplate in the longitudinal direction, an inner sleeve disposed between the endplate and the endcap, filter media at least partially surrounding the inner sleeve; and an outer sleeve at least partially surrounding the filter media. The inner sleeve may include an inner sleeve sidewall defining a volume in fluid communication with the at least one outlet and having a plurality of holes through the sidewall. The outer sleeve may include at least one protrusion and at least one opening. The outer sleeve may be spaced from an inner surface of the housing sidewall and the inlet may be in fluid communication with the space between the outer sleeve and the inner surface of the housing.

### BRIEF DESCRIPTION OF DRAWINGS

FIG. 1 is an exploded side view of a filter element including filter media, in accordance with an example embodiment of the present disclosure.

FIG. 2 is a cross-sectional view of the filter element illustrated in FIG. 1, in accordance with an example embodiment of the present disclosure.

FIG. 3 is a partial cross-sectional view of the filter element illustrated in FIGS. 1 and 2, taken along section 3-3 in FIG. 2, in accordance with an example embodiment of the present disclosure.

FIG. 4 is a cross-sectional view of a filter assembly including the filter element illustrated in FIGS. 1-3, in accordance with an example embodiment of the present disclosure.

FIG. 5 is a cross-sectional side view of another filter assembly including filter media and a housing, in accordance with additional example embodiments of the present disclosure.

FIG. 6 is a partial cross-sectional view of the filter assembly illustrated in FIG. 5, taken along section 6-6 in FIG. 5, in accordance with an example embodiment of the present disclosure.

FIG. 7 is a side view of a sleeve for use in a filter assembly, in accordance with an additional example embodiment of the present disclosure.

### DETAILED DESCRIPTION

This disclosure generally relates to fluid filters. For example, filters described herein may be used to filter fluids such as, for example, fuel, lubricants, coolants, and hydraulic fluid. In at least one example, the filters described herein may be used in connection with engines, such as fuel-based internal combustion engines, to filter fuel and/or oil. Wherever possible, the same reference numbers will be used through the drawings to refer to the same or like features.

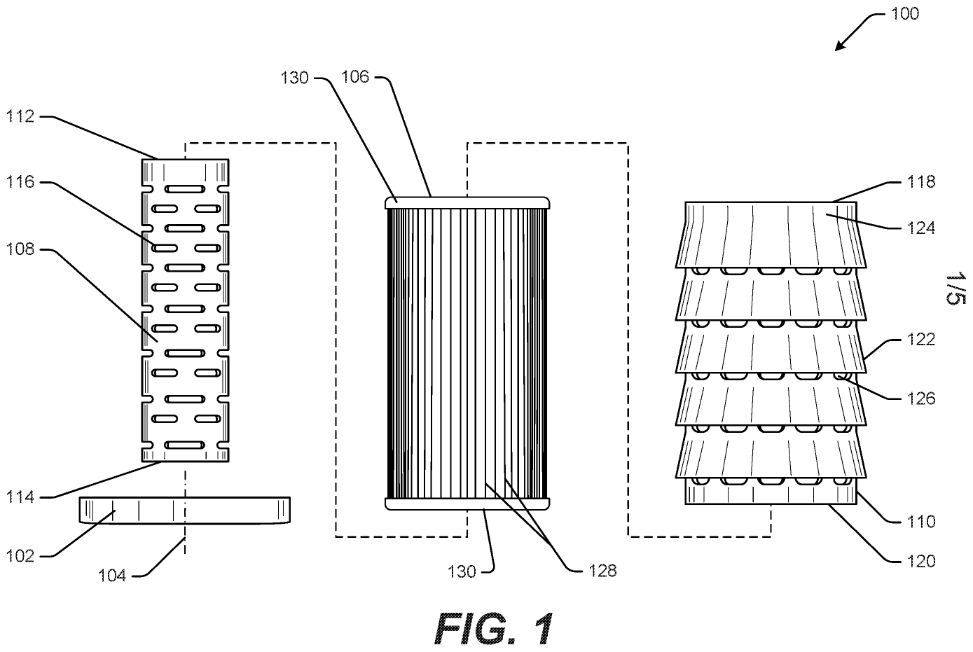

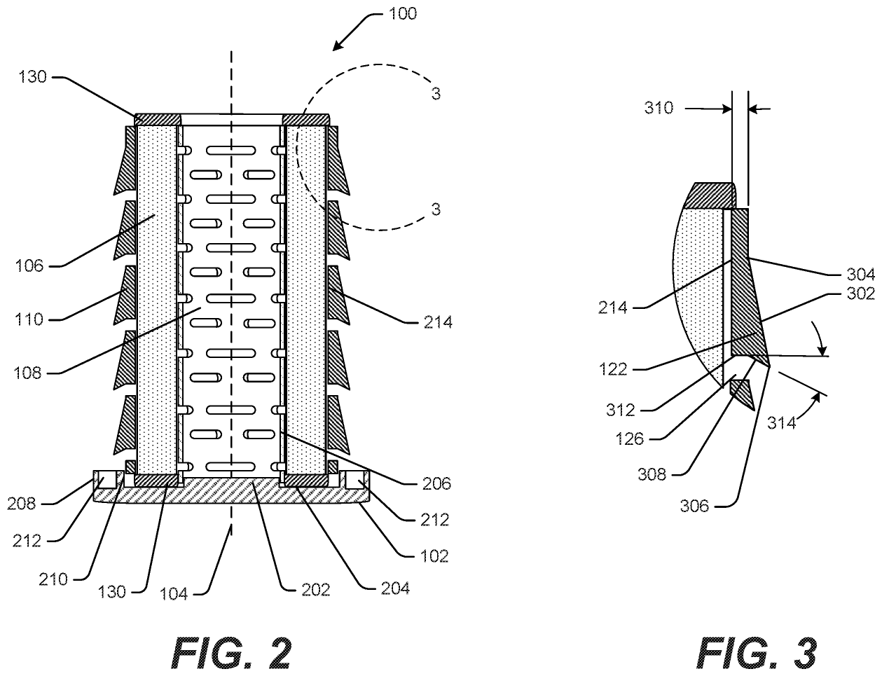

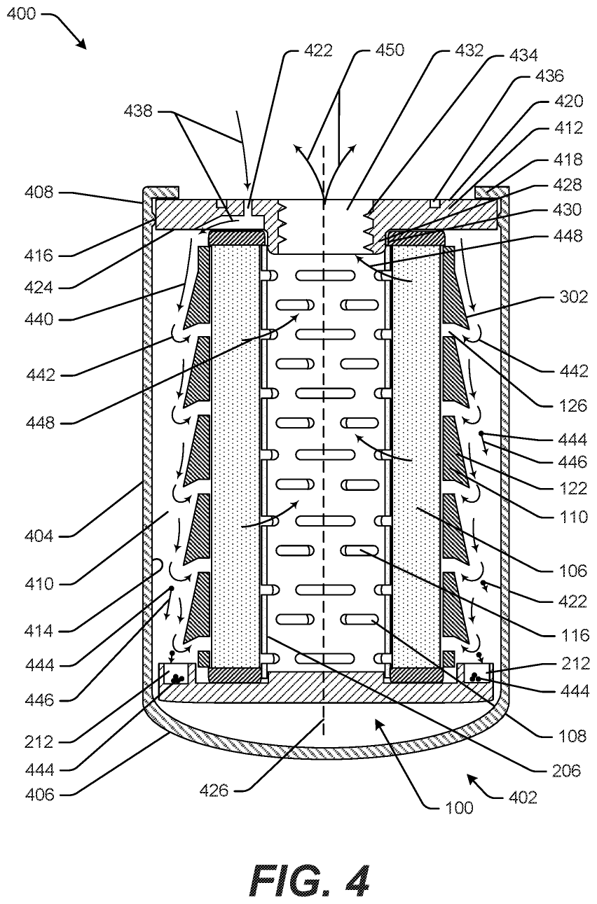

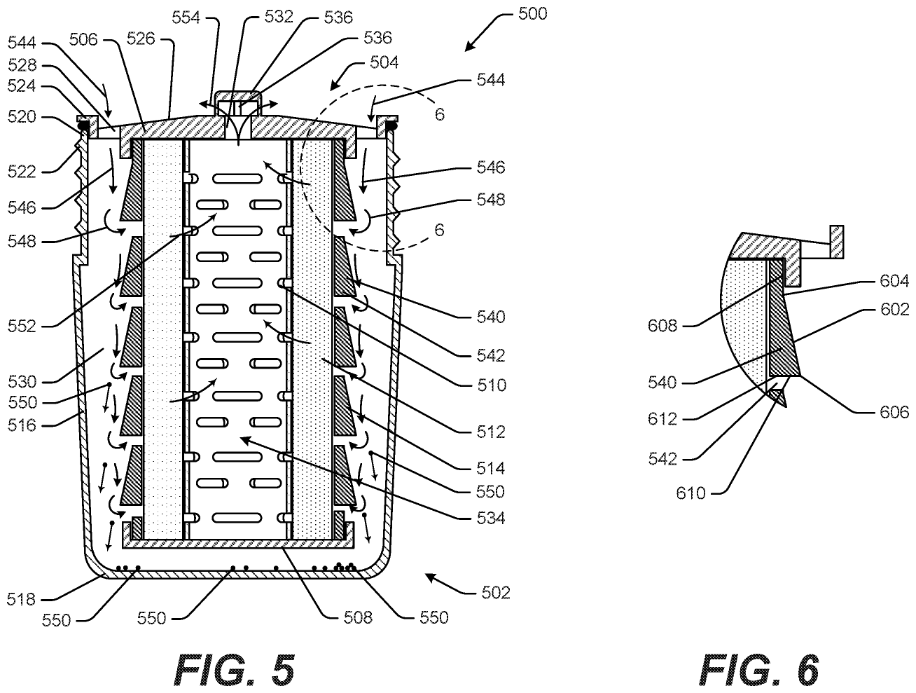

Referring to FIG. 1, an example filter element 100 generally includes an endcap 102 forming a bottom (as oriented in the Figure) of the filter element 100. The illustrated endcap 102 may be generally cylindrical, e.g., about a longitudinal axis 104, although in other implementations the endcap 102 may be other than cylindrical. The filter element 100 also includes one or more of a filter media 106, an inner sleeve 108, and/or an outer sleeve 110 disposed on the base endcap 102 and extending generally in a longitudinal direction, i.e., along the longitudinal axis 104 of. In some examples, the filter media 106 may be generally cylindrical and the inner sleeve 108 may be disposed in an opening in the filter media 106. For example, the opening, which is shown more clearly in FIG. 2, may be a cylindrical opening extending longitudinally through the filter media 106. The outer sleeve 110 may be configured to be disposed over, e.g., at least partially around, the filter media 106, as described further herein. Although not illustrated in FIG. 1, in embodiments described herein, the filter element 100 may be retained in an outer housing or canister. Example housings are shown in FIGS. 4 and 5, for example, and those figures are described in more detail below.

As noted above, the endcap 102 is disposed at an end, e.g., a bottom, of the filter element 100. Although not illustrated in FIG. 1, a top plate or opposing endcap may also be provided, disposed at an opposite, e.g., top, end of the filter media 106. The plate may include a plurality of openings via which fluid may pass. For instance, and as described further herein, fluid may enter into contact with the filter element 100 through one or more inlets formed through the opposing plate or endcap, and, once filtered, may exit the filter element 100 through one or more outlets. While examples described herein may include both inlets and outlets in the non-illustrated endcap, in other embodiments fluid may otherwise flow into contact with the filter element 100. For instance, techniques described herein may be used with arrangements in which fluid can enter the filter element via an inlet positioned other than in an endcap and/or can exit the filter element via an outlet positioned other than in an endcap. By way of non-limiting example, the inlet and/or the outlet may be formed as a hole through the endcap 102 in other examples. In some implementations, however, the position of the inlet and the outlet may depend upon an outlet and inlet, respectively, of the source of the fluid to be filtered.

The filter media 106 may include any composition and/or construction that removes one or more contaminants from a fluid to be filtered. In examples described herein, the filter media 106 may filter the fluid as the fluid passes through the filter media 106. In some examples, the filter media 106 may include a coalescing-type media configured to promote separation of a first fluid from a second fluid having different characteristics from the first fluid. For example, the first and second fluids may be separated as a combined fluid including both the first fluid and the second fluid passes through the filter media 106. In some examples, the fluid to be filtered may include water and fuel. Depending upon the application, the fluid may be diesel fuel, lubricating oil, hydraulic oil, or any fluid known to those skilled in the art. In other embodiments, the filter media 106 may be a barrier-type media. In some examples, the filter media 106 may include a paper- or textile-based filter media. In the illustrated embodiment of FIG. 1, for example, the filter media 106 may include a number of longitudinally-extending pleats 128 generally formed into a cylindrical shape and retained between opposing ends 130. For instance, the opposing ends 130 may be integrally formed with the filter media, e.g., to fix longitudinal ends of the filter media 106. Other media types may also or alternatively be used in embodiments of this disclosure, and in some implementations, the ends 130 may not be included.

The inner sleeve 108 may be a tubular, e.g., cylindrical, member having a first end 112 configured to be spaced from the endcap 102, and an opposite, second end 114 configured to be disposed adjacent to the endcap 102. When the filter element 100 is assembled, the inner sleeve 108 may be disposed in a longitudinal opening in the filter media 106, e.g., such that the filter media 106 is at least partially disposed around the inner sleeve 108. In some examples, the opening of the filter media 106 may have a diameter closely approximating an outer diameter of the inner sleeve 108. For example, the inner sleeve 108 and the filter media 106 may be retained together by an interference fit, although in other embodiments the opening of the filter media 106 me be such as to provide clearance relative to the outer diameter of the inner sleeve 108. As described further herein, the inner sleeve 108 may include a number of openings 116. The openings 116 may permit fluid passing through the filter media 106, e.g., fluid filtered by the filter media 106, to pass through the inner sleeve 108 and into an inner cavity or volume defined by the inner sleeve 108. As detailed further herein, the cavity may be in fluid communication with an outlet or similar opening to allow fluid passing through the filter media 106 and into the opening defined by the inner sleeve 108 out of the filter element 100.

In some examples, the inner sleeve 108 can be secured and/or sealed relative to the endcap 102. For instance, the endcap 102 may include a boss, a post, grooves, and/or some other physical feature for aligning the inner sleeve 108 relative thereto and/or for securing the inner sleeve 108 thereto. By way of nonlimiting example, the inner sleeve 108 may be secured to the endcap 102 via an interference fit. In other implementations, other fastening means, including, but not limited to adhesives, fasteners, and/or the like may be used to secure the inner sleeve 108 to the endcap 102. In still further embodiments, the endcap 102 may be a polymer or resin, which may be cured to at least one of the inner sleeve 108, the filter media 106, and/or the outer sleeve 110. As noted above, in some implementations, it may be desirable to seal the inner sleeve 108 relative to the endcap 102, e.g., to prevent fuel filtered by the filter media 106 from seeping between the adjoining surfaces of the inner sleeve 108 and the endcap 102.

The outer sleeve 110 may also be a tubular, e.g., cylindrical member. As illustrated, the outer sleeve 110 may extend from a first end 118 to a second end 120, with the second end 120 being configured to be adjacent to the endcap 102 and the first end 118 spaced therefrom. The outer sleeve 110 is configured for positioning at least partly over the filter media 106. For example, the outer sleeve 110 may have an inner diameter (not shown) approximately equal to or larger than an outer diameter of the filter media 106. As also illustrated in FIG. 1, the outer sleeve 110 includes a number of protrusions 122 extending outwardly from an outer surface 124 and a plurality of openings or holes 126 through the outer sleeve 100, near the protrusions 122. As illustrated, the protrusions 122 may be formed as annular rings around the circumference of the outer surface 124 having an angled profile, with the holes 126 below, e.g., closer to the endcap 102 than, the protrusions 122. As will be described further herein, the protrusions 122 may route fluid flowing into the filter element 100, e.g., through one or more inlets in an endplate, before the fluid contacts (and passes through) the filter media 106.

Unlike in conventional filter elements, and as described further herein, fluid may pass through the outer sleeve 110 via the holes 126 before coming into contact with the filter media 106. Accordingly, in some implementations, the protrusions 122, which may be formed as a plurality of louvers or other angled surfaces, act as a barrier or other impediment around which fluid must flow prior to coming into contact with the filter media 106. For example, as the fluid is forced to navigate the protrusions 122 before entering the holes 126, some heavier and/or larger contaminants may separate from the fluid, e.g., under the effects of centrifugal and/or gravitational forces. Fluid flow and removal of contaminants according to implementations of this disclosure will be detailed further below, with reference to additional figures.

FIG. 2 is a cross-sectional illustration of the filter element 100, when assembled. As illustrated, the filter media 106 generally surrounds the inner sleeve 108, while the outer sleeve 110 generally surrounds the filter media 106. Thicknesses, clearances, and similar attributes of the components of the filter element 100 are shown for example only, and this disclosure is not limited to the shown dimensions, configurations, clearances, and the like.

FIG. 2 shows additional details of the endcap 102. More specifically, FIG. 2 illustrates that the endcap 102 may include a boss 202. The boss 202 may be a generally cylindrical protrusion, extending from a top surface 204 of the endcap 102, e.g., toward a top of the filter element 100. The boss 202 may promote coupling and/or positioning of the endcap 102 relative to the inner sleeve 108. Also in some examples, the boss 202 may provide a sealing engagement with an inner surface 206 of the inner sleeve 108 in some implementations. At its outer periphery, the endcap 102 may also include a skirt or flange 208 extending generally in the longitudinal direction from the top surface 204, e.g., toward the top of the filter element 100. The flange 208 may include an inner surface 210. In the illustrated embodiment, the inner surface 210 may define a diameter that is similar to an outer diameter of the outer surface 124 proximate the second end 120 of the outer sleeve 110. In some implementations, the inner surface 210 may promote correct positioning of the outer sleeve 110 relative to the endcap 102, e.g., by contacting the outer surface 124.

FIG. 2 also illustrates a channel 212 formed in the flange 208. As illustrated, the channel 212 may be a notch or cut out, and may be formed around the entire circumference. In other embodiments, the channel 212 may comprise a number of spaced-apart, e.g., circumferentially spaced-apart, channels. Although FIG. 2 illustrates the channel 212 as being generally square in cross-section, other profiles, including arcuate, angled, and/or the like also may be used. The illustrated depth is also for illustration only. For instance, the depth may be deeper or shallower and/or may vary about the circumference of the endcap 102. In other examples, at least a portion of the channel 212 may extend entirely through the endcap 102. Thus, for example, in some implementations, the channel 212 may include one or more apertures. In practice, and as described further herein, the channel 212 may act as a collecting area or trap into which particulates in fluid flowing through the filter element 100 may settle and be collected. Particulates trapped in the channel 212 are less likely to come into contact with the filter media 106, e.g., by being maintained out of a flow path of fluid in the filter element 100.

FIG. 2 also illustrates additional details of the outer sleeve 110. For example, FIG. 2 illustrates that the outer sleeve 110 includes an inner surface 214 arranged to face the filter media 106. In some instances, portions of the inner surface 214 may contact the filter media 106, although maintaining a gap therebetween will promote flow of fluid approaching the filter media 106 via the holes 126 to flow to areas of the filter media 106 not exposed by the holes 126. As shown, the inner surface 214 may be substantially cylindrical, although other shapes or profiles that allow for the outer sleeve 110 to at least partially surround the filter media 106 may alternatively be used. FIG. 2 also shows the protrusions 122 in cross-section, and FIG. 3 provides a further enlarged view of a portion of the filter element 100 including one of the protrusions 122. Additional details of the protrusions 122 will be described with reference to FIG. 3.

More specifically, and with specific reference to FIG. 3, the protrusion 122 may provide a varied, e.g., non-cylindrical, contouring relative to the outer surface 124. More specifically, the protrusion 122 may include an inclined surface 302 extending, generally in the longitudinal direction, from a first end 304, generally closer to the first end 118 (e.g., the top) of the outer sleeve 110, to a second end 306 generally further from the first end 118. As illustrated, the first end 304 may be a junction or transitional area between the inclined surface 302 and the substantially cylindrical outer surface 124. In contrast, in addition to being longitudinally offset from the first end 304, the second end 306 is disposed radially outwardly relative to the first end 304. Accordingly, the inclined surface 302 is configured to be further away from a nominal cylindrical surface having a diameter at the first end 304.

As illustrated in FIG. 3, the protrusion 122 also includes an end surface 308. The end surface 308 generally extends radially inwardly from the second end 304 of the inclined surface 302, e.g., to the outer surface 124. As also illustrated, the end surface 308 is angled relative to a plane to which the longitudinal axis of the filter element 100 is normal. Thus, the angled surface 302 and the end surface 308 may form angled legs, e.g., formed in a modified “V” shape, with both legs also being angled (at a non-zero and non-90-degree angle) relative to the longitudinal axis 208 of the outer sleeve 110. In some examples, the inner surface 214 of the outer sleeve 110 and the outer surface 124 of the outer sleeve 110 may be substantially cylindrical, defining a nominal thickness 310 of the outer sleeve 110 therebetween. In this example, the protrusions 122 may be annular undulations altering this nominal thickness along the length of the outer sleeve 110. For example, the protrusions 122 may be formed as a plurality of louvers or angled surfaces. As will be appreciated, the angle 314, the angle of the angled surface 302 relative to a reference, and/or the angle of the end surface 308 relative to the angled surface 302 are not limited to the illustrated example. Other angles may be used without departing from this disclosure.

As also illustrated in FIG. 3, one of the holes 126 may be formed substantially adjacent to, e.g., directly below, the end surface 308. Also in the illustrated example, the hole 126 may extend through the thickness 310 of the outer sleeve 110, generally normal to both the inner surface 214 and the outer surface 124. Thus, as illustrated in FIG. 3, an inner wall 312 of the opening 126 may be generally normal or perpendicular to the inner surface 214 of the outer sleeve 110. In contrast, the end surface 308 of the protrusion 122 may be angled relative to the inner wall 312, e.g., by the angle 314 shown in FIG. 3. In the example, the angle 314 causes the second end 306 of the angled surface 302 to overlap the opening 126, e.g., such that end surface 306 partly occludes or blocks the opening 126. Stated differently, the second end 306 of the inclined surface 302 is, in the longitudinal direction, farther from the first end 118 of the outer sleeve 110 than at least a portion of the opening 126.

The example of FIG. 3 is for illustration only, and modifications are contemplated. For example, although the openings 126 are illustrated as being substantially normal to the inner surface 214 of the outer sleeve 110, in other configurations the openings 126 may be angled relative to normal. For instance, the openings 126 may be angled at the angle 314 such that at least a portion of the inner wall 312 aligns with the end surface 308. This arrangement may promote easier manufacturing, for example. Also in some examples, the angle 314 may be greater or less than shown. A greater angle may cause the protrusion to extend further over the opening 126 whereas a smaller angle may cause the protrusion 122 to occlude less of the opening. In some examples, the angle 314 may be zero, e.g., such that the end surface 308 is substantially normal to the inner surface 214. An example of this arranged is shown in FIG. 5, below, for example. Moreover, although the inclined surface 302 and the end surface 308 are illustrated and described as substantially planar surfaces, e.g., sharing an edge at the second end 306 of the inclined surface 302, in other implementations the surface may have one or more different profiles. For example, the inclined surface 302 and/or the end surface 308 may be curved, e.g., concave and/or convex, may be stepped, and/or may have additional shapes. Moreover, although in the illustrated example the first end 304 and the second end 306 generally are illustrated as edges, e.g., at the junction of two features, in other implementations the “ends” may generally refer to a region or section that generally denotes a transition between features. By way of non-limiting example, while the inclined surface 302, the second end 306, and the end surface 308 are generally shown as forming an angled cross-section, in other implementations, the second end 306 may be arcuate, e.g., to providing a curved, smooth transition from the inclined surface 302 to the end surface 308. With the benefit of this disclosure, other arrangements also may be contemplated that force fluid flow generally outward relative to the outer sleeve 110, as detailed further herein.

FIG. 4 illustrates the filter element 100 as a component of an example filter assembly 400. More specifically, in the filter assembly 400, the filter element 100 is disposed in a filter housing 402. The filter housing 402 may include a generally cylindrical sidewall 404 extending (e.g., along a longitudinal dimension) between a closed end 406 and an opposite, open end 408. The sidewall 404 and the closed end 406 generally define a volume 410 within which at least a portion of the filter element 100 may be disposed.

More specifically, in the illustrated example, the filter assembly 400 (or the filter housing 400) may also include an endplate or mounting plate 412 configured for placement in the open end 408 of the filter housing 402. Although the mounting plate 412 is shown separate from the filter housing 402, the mounting plate 412 and the filter housing 402 can be integrated and/or differently separated. As illustrated in FIG. 4, the filter element 100 may be disposed in the volume 410 such that an outer periphery of the mounting plate 412 is sealed relative to an inner surface 414 of the sidewall 404, proximate the termination of the sidewall 404 at the open end 408. An annular protuberance 416 or other sealing feature may be provided on the inner surface 414 of the sidewall 404. When assembled, the protuberance 416 may contact the outer periphery of the mounting plate 412 to secure the mounting plate 412 relative to the sidewall 404. Although not illustrated, an annular receptacle or groove may also be disposed in the outer periphery of the mounting plate 412, e.g., to receive or otherwise cooperatively engage the protuberance 416. In addition, one or more seals, gaskets, O-rings, or the like may be provided to create a seal between the mounting plate 412 and the filter housing 402. Accordingly, in the arrangement of FIG. 4, the volume 410 may be a sealed volume defined generally by the sidewall 404, the closed end 406, and the mounting plate 412. As also illustrated in FIG. 4 the filter element 100 may be disposed in the sealed volume. FIG. 4 also illustrates that the distal ends of the sidewall 404 of the housing can be overturned to form overturned edges 418 that extend at least partially over a top surface 420 of the mounting plate 412. For example, the overturned edges 418 may prevent removal of the mounting plate 412 and/or the filter element 100, once the filter assembly 400 is assembled.

As also illustrated in FIG. 4, the mounting plate 412 also includes one or more inlets 422 (one of which is illustrated) formed therethrough. The inlet(s) 422 are openings extending from the top surface 420 of the mounting plate 412 to a bottom surface 424 of the mounting plate 412. Although only a single inlet 422 is shown, multiple inlets 422, e.g., circumferentially spaced, may be provided. The inlet(s) 422 may include holes, slots, passageways, conduits or other openings via which fluid can pass through the mounting plate 412. In FIG. 4, the inlet(s) 422 may be configured to define a passageway that extends in both an axial direction, e.g., along a longitudinal axis 426 of the filter assembly 400, and a radial direction. Stated differently, in the example of FIG. 4, the inlet 422 includes an opening at the top surface 420 that is spaced radially inwardly from at least a portion of an opening at the bottom surface 424. Accordingly, fluid entering the inlet 422 proximate the top surface 420 and exiting the inlet 422 proximate the bottom surface 424 may flow radially outwardly (in addition to longitudinally through the mounting plate 412). Other configurations of the inlet(s) 422 also are contemplated. For instance, in some other examples, the inlet(s) 422 may be generally axially-extending holes, e.g., such that fluid passing therethrough may not move radially. As also illustrated in FIG. 2, the inlets 422 may be disposed such that fluid exiting the inlet proximate the bottom surface 424 may come into contact with the outer surface 124 of the outer sleeve 110.

As also illustrated in FIG. 4, the mounting plate 412 may include a boss 428. In the illustrated example, the boss 428 may be a substantially cylindrical protuberance extending or protruding from the bottom surface 424 of the mounting plate 412, i.e., away from the top surface 420. In some examples, the boss 428 may facilitate securement and/or positioning of the filter media 106 and/or the inner sleeve 108 relative to the mounting plate 412. For instance, the boss 428 may have an outer diameter closely approximating the inner diameter of the inner surface 206 of the inner sleeve 108 and/or an inner surface 430 of an opening through the end 130 of the filter media 106. In some examples, the outer diameter of the boss 428 may be sized to create an interference fit with the inner surface 206 of the inner sleeve 108 and/or the inner surface 430 of the end 130 of the filter media 106. For example, such an interference fit may substantially seal the mounting plate 412 relative to the inner sleeve 108 or the filter media 106, although sealing may not be necessary in some embodiments. For instance, the boss 428 and the inner sleeve 108 and/or the end 130 of the filter media 106 may be configured to provide clearance therebetween. In this example, the inner sleeve 108 and/or the opening in the end 130 may loosely fit over the boss 428. In such an example, the boss 428 may still serve generally to position the inner sleeve 108 and/or the filter media 106 relative to the mounting plate 412, despite the absence of a press or interference fit. Moreover, the boss 428 is merely one example of a feature for positioning and/or sealing the mounting plate 412, the inner sleeve 108, and/or the filter media 106 relative to each other. By way of non-limiting example, in other embodiments the top end 114 of the inner sleeve 108 and/or a portion of the end 130 could be received in a groove, bore, or other featured formed in the bottom surface 424 of the mounting plate 412. In yet another example, the boss 428 may be replaced with a key or other non-cylindrical shape that cooperates with a mating receptacle, slot, or shape on the inner sleeve 108 and/or the cap 130. Other features that allow for positioning of the inner sleeve 108 and/or the filter media 106 relative to the mounting plate 412 may alternatively be used. In other examples, the boss 428 and/or similar features may not be included at all.

As also illustrated in FIG. 4, the mounting plate 412 may include an outlet 432 extending therethrough, e.g., from the top surface 420 to the bottom surface 424. In the illustration, the outlet 432 is coaxial with the longitudinal axis 426, although the outlet 432 may be otherwise positioned through the mounting plate 412. In some embodiments, the outlet 432 may include more than one opening. The outlet 432 generally provides a fluid passageway from inside the inner sleeve 108 to a position outside the filter assembly 400. When in use, the outlet 432 may be in fluid communication with an inlet or port on an engine or the like. For example, FIG. 4 also illustrates that the mounting plate 412 may include one or more threads 434 on an inner surface of the outlet 432. The threads 434 may be provided to couple the filter assembly 400 to an engine or the like. Although the outlet 434 is illustrated as being formed through the mounting plate 412, the disclosure is not limited to this configuration. For instance, in some implementations, the positioning and/or construction of the inlet(s) 422 and/or the outlet 432 may depend on the arrangement of the engine or other device to which the filter assembly 400 is coupled. By way of non-limiting example, the inlet(s) 422 and/or the outlet 432 could be formed in the endcap 102 and/or extend through an additional or alternative port in the housing 402.

As also illustrated in FIG. 4, the mounting plate 412 may also include an annular groove 436 formed in the top surface 420. In some examples, the annular groove 436 may be configured to receive a seal (not shown), which may be a gasket or an O-ring, for example. In some implementations, the seal may contact a surface of an engine or other device to which the filter assembly is to be coupled (e.g., via the threads 434), e.g., to seal the filter assembly 400 to the engine/device. As will be appreciated, the mounting plate 412 may act as an endplate with the filter media 106, the inner sleeve 108 and the outer sleeve 110 being positioned to extend axially between the mounting plate 412 and the endplate 102.

The inlets 422, the boss 428, the outlet 432, the threads 434, and the groove 436 are provided for example only. Other configurations for the mounting plate 412, including alternatives and additions discussed above, may be appreciated by those having ordinary skill in the art. Moreover, the mounting plate 412 may not include some of the illustrated features. As noted above, the location and/or inclusion of certain features may also be dependent upon a configuration of the engine or other device or system to which the filter assembly 400 is to be coupled.

As also shown in FIG. 4, fluid to be filtered may enter the sealed volume 410 via the inlet(s) 422, e.g., along inlet arrows 438. In some examples, the filter assembly 400 may be a part of an active system, in which the fluid enters the sealed volume 410 under some external pressure or force. Once in the volume 410, the fluid may contact the outer sleeve 110, and proceed, under the force of gravity and/or an external pressure, generally along the inclined surface 302, as shown by arrows 440. As discussed above, the profile of the inclined surface 302 may act to direct the fluid away from the filter media 106. As the volume 410 fills and/or additional fluid is forced into the volume 410, however, the fluid will be forced through the holes 126, e.g., by proceeding around the protrusions 122 generally along arrows 442. Flowing generally along the arrows 442 imparts centrifugal forces on the fluid. Such forces, and in some instances other and/or additional forces, including but not limited to gravitational forces, cause particulates 444 and/or other contaminants in the fluid to exit the fluid. As illustrated in FIG. 4, the particulates 444 may be forced away from the path of the fluid, e.g., along a direction shown by the arrows 446. In examples, the particulates 444 may settle into the channel 212, where they are retained separately from the flow of fluid.

With the particulates 444 removed, fluid passing through the holes 126 comes into contact with the filter media 106. Then, as the fluid passes through the filter media 106, it passes through the openings 116 in the inner sleeve 108, generally along arrows 448. Filtered fluid in the inner sleeve 108 then exits the filter assembly 400 via the outlet 432, generally along outlet arrows 450. As will be appreciated, the filter assembly 400 may be installed, e.g., coupled to an engine, or similar structure, such that the inlet(s) 422 are in fluid communication with an outlet of the engine/source of fluid to be filtered, and the outlet 432 is in fluid communication with an inlet of the engine/source, e.g., to receive the filtered fluid.

The described fluid flow is contrary to several conventional constructions, in which fluid entering the filter assembly 400 may come directly into contact with the filter media. For example, in some conventional arrangements, the filter media 106 is directly exposed to the volume 418, e.g., without any covering like the outer sleeve 110. According to aspects of this disclosure, however, fluid must flow around the protrusions 122 to contact the filter media via the holes 126. As illustrated, this flow path may cause the fluid to counter gravity and/or centrifugal forces to enter the holes 126. As the fluid navigates this flow path, heavier particulate and/or other contaminants in the fluid may fall out of the fluid, e.g., under the force of gravity and/or the centrifugal forces. Stated differently, the protrusions 122 alter the flow of the fluid such that some contaminants may fall or be forced out of the fluid, e.g., via one or more of gravitational forces, centrifugal forces, and/or the like. Also in embodiments described herein, the channel 212 may act to capture and/or retain such contaminants.

In examples of this disclosure, although the outer sleeve 110 may be configured to alter a flow path of fluid, the outer sleeve 110 may also be configured to limit an amount of fluid impeded by the outer sleeve 110. That is, the outer sleeve 110 may redirect the flow of fluid to be filtered, but it may also be designed to mitigate any reduction in throughput for the filter assembly 400, relative to conventional filter assemblies and/or target performance characteristics. For example, the holes 126 may be sized and/or numbered in accordance with one or both of a flow rate of the filter media 106 and/or the inner sleeve 108. By way of non-limiting example, the holes 126 may have a combined area that is equal to or greater than a combined area of the openings 116. In this manner, although the outer sleeve 110 may necessarily impede some fluid flowing into contact with the filter media 106, the outer sleeve 110 does not impede the flow of fluid through the filter assembly 400, e.g., relative to conventional filter designs and/or relative to a preferred or required throughput for the filter assembly 400. The filter housing 402 may also be configured to minimize an effect on the throughput of fluid. By way of non-limiting example, the filter housing 402 may be sized to accommodate the outer sleeve 110 while still maintaining the volume 410 at a desired or required size. Moreover, an inner diameter of the inner surface 414 of the sidewall may be sized to provide a minimum desired spacing between the inner surface 414 and the protrusions 122, e.g., to allow fluid to freely flow between the outer sleeve 110 and the inner surface 414.

FIG. 5 is a cross-sectional view of another example filter assembly 500 according to examples of this disclosure. Like the filter assembly 400, the filter assembly 500 generally includes a housing 502, an endplate 506, and a filter element 504 at least partially disposed in the housing 502. As illustrated, the filter element 504 may be similar to the filter element 100, and can include an endcap 508, an inner sleeve 510, filter media 512, and an outer sleeve 514. When assembled, the inner sleeve 510, the filter media 512, and the outer sleeve may be disposed between the endplate 506 and the endcap 508. The function of the filter assembly 500 may be substantially the same as that of the filter assembly 400, but, as illustrated, the filter assembly 500 may have a number of differences relative to the filter assembly 400. Some of these differences will now be discussed in more detail.

As illustrated, the housing 502 may include a sidewall 516 extending generally longitudinally between a closed end 518 and an open end 520. Proximate the open end 520, the housing 502 may also include one or more threads 522. For example, the threads 522 may be formed on an outer surface of the sidewall 516. In implementations, the threads 522 may be used to attach the filter assembly 500 to a source of the fluid to be filtered. In this example, the filter assembly 500 may be a “canister” type filter assembly 500, with the threads 522 providing a mechanism for fastening the filter assembly 500 to an engine or the like. As also illustrated, the threads 522 may be formed on a portion of the sidewall 516 that is offset (e.g., radially inwardly) relative to a remainder of the sidewall 516. In this example, the threads 522 may not extend beyond an outer diameter of the sidewall 516, e.g., relatively closer to the closed end 518 of the housing 502. In other implementations, the sidewall 516 could include other profiles, including profiles in which one or more of the threads 522 extend radially outwardly farther than all portions of the sidewall 516.

FIG. 5 also illustrates modifications to the endplate 506 (relative to the mounting plate 412 discussed above). For example, as illustrated, the endplate 506 includes a flange 524 configured to contact a distal end of the sidewall 514, e.g., proximate the open end 520. A seal, gasket, or the like may be disposed between the flange 524 and the terminal end of the sidewall 516 to seal the filter assembly 500. In some implementations, the flange 524 may rest on the seal or gasket, e.g., with the filter element 504 disposed in the housing 502. For instance, the filter element 504 may be readily removable from the housing 502. In such examples, coupling the filter assembly 500 to an engine, e.g., by engaging the threads 522 with mating threads formed on the engine, may cause the flange 524 to seat or otherwise draw into close contact with the housing 502, e.g., by compressing the seal between the flange 524 and the distal end of the sidewall 516. Although not illustrated, a second seal, gasket or the like may also be provided on a top surface of the flange 524, for example, to promote sealing of the filter assembly 500 to the engine. According to some examples, when the filter assembly 500 is unthreaded from the engine or the like, the filter element 504 may be removed and cleaned and/or replaced. In contrast, the filter assembly 400 described above may be a disposable assembly, e.g., in which the filter element 100 is not readily removable from the housing 402.

Also in the filter assembly 500, a top surface 526 of the endplate 506 may be angled or sloped. For example, the sloped top surface 526 may promote flow of fluid contacting the top surface 526 into peripherally-disposed inlets 528. For example, fluid to be filtered may enter a volume 530 inside the filter assembly 500 via the inlets 528. As also illustrated in FIG. 5, an outlet 532 may be formed through the endplate 506. The outlet 532 may be in fluid communication with an inner chamber 534 defined by the inner sleeve 510. A covering 536 may also be spaced from the top surface 526 by one or more legs 538, i.e., over the outlet 532. For example, the covering 536 may redirect generally longitudinally-flowing fluid radially outwardly as it exits the filter assembly 500 via the outlet 532.

The endcap 508 may retain and/or position one or more of the inner sleeve 510, the filter media 512, and/or the outer sleeve 514. In some implementations, the endcap 508 may be substantially similar to the endcap 102 discussed above. Unlike the endcap 102 illustrated in FIGS. 1-3, however, the endcap 508 may not include a channel. As noted above, a channel like the channel 212 may capture and/or retain particulates separated from a fluid flowing through the filter assembly, whereas in the example of FIG. 5, such particulates may fall to a position proximate the closed end 518 of the housing 502, e.g., to a bottom of the filter housing 502. In other implementations, the endcap 508 may include a channel, however.

The outer sleeve 514 may include a number of protrusions 540 extending therefrom and a number of openings or holes 542 formed therethrough. For example, the protrusions 540 may function similarly to the protrusions 122 discussed above, e.g., to provide a contoured or undulating outer surface that redirects fluids first away from the filter media 512 before the fluid eventually comes into contact with the filter media 512, but may be constructed differently. For example, and as best illustrated in FIG. 6, the protrusions 540 may include an inclined surface 602 extending from a first end 604 to a second end 606 spaced from the first end 604 in the longitudinal direction. As illustrated, the first end 604 is disposed radially-inwardly of the second end 606. Stated differently, the first end 604 may be a transitional edge or region between the protrusion 540 and an outer surface 608 of the outer sleeve 514, whereas the second end 606 may be longitudinally spaced from the first end 604 and radially spaced from, e.g., radially outward of, the outer surface 608. In the example, an end surface 610 extends radially inwardly from the second end 606 to the outer surface 608 of the outer sleeve 514. Accordingly, in profile, the angled surface 602 and the end surface 604 are angled relative to each other, as well as relative to the outer surface 608 of the outer sleeve 514. Also in the example illustration, the end surface 610 may be coincident with an inner surface 612 of an adjacent one of the openings 542. Thus, in the example of FIGS. 5 and 6, the end surface 610 is generally normal to a longitudinal axis of the filter element 500. Accordingly, the protrusion 540 may not occlude the openings 542, e.g., the openings 542 are completely exposed. The illustrated angles are for example only, however. For instance, an angle between the angled surface 602 and the end surface 606 may be larger or smaller than shown. Moreover, the end surface 606, instead of being coplanar with the inner surface 612 of the opening 542 could be angled relative thereto in some examples.

The filter assembly 500 may include different features than the filter assembly 400, but it may function in substantially the same manner. More specifically, and as illustrated in FIG. 5, fluid to be filtered may enter the filter assembly 500 via the inlets 528, as generally shown by inlet arrows 544. Inside the volume 530, the fluid is forced radially outwardly by the protrusions 540, as generally shown by arrows 546, and enters the openings 542 only after navigating around the protrusions 540 as generally shown by arrows 548. As the fluid navigates the protrusions 540, as shown by the arrows 546, 548, particulate matter 550 in the fluid may drop or otherwise be forced out of the fluid, e.g., via centrifugal forces, gravitational forces, and/or the like. Fluid entering the openings 542, e.g., from which the particulates are removed, may then pass through the filter media 512 and proceed into the inner chamber 534 defined by the inner sleeve 510, generally along arrows 552. Fluid then leaves the filter assembly 500 through the outlet 532, generally along the outlet arrows 554. Thus, as illustrated, the protrusions 540 may force fluid to travel along a flow path that includes a turn of over 90-degrees, and in some instances up to 180-degrees. As a result of navigating this flow path and/or because of the impact of gravity, the particulates 550 may fall from the fluid. As illustrated in FIG. 5, the particulates 550 may collect in the filter housing 502, e.g., proximate the closed end 518.

As noted above, the filter assemblies 400, 500 are example implementations of this disclosure. Aspects of each of the filter assemblies 400, 500 may be incorporated into the other. For example, while FIG. 5 shows a number of modifications to the assembly shown in FIG. 4, and additional modifications are discussed in the descriptions of the assemblies 400, 500 and their components, those skilled in the art, with the benefit of this disclosure, will understand that different combinations also are contemplated by (and included in) this disclosure. By way of non-limiting example, the filter element 100 may be used in the housing 502, the endplate 506 and/or the endcap 508 can be used in the filter element 100, and/or the outer sleeves 110, 514, instead of being used in the filter elements 100, 504, respectively, can be used in the other filter elements. Moreover, components illustrated in FIGS. 1-6 may be omitted in some implementations. By way of non-limiting example, the inner sleeves 108, 510 may be optional in some examples. For instance, the filter media 106, 512 may be sufficiently structurally rigid that the inner sleeve 108, 512 may be superfluous. Moreover, although the inner sleeve, filter media and outer sleeve are shown as separate, separable components, in other implementations two or more of these components can be integrally formed. For example, the inner sleeve may be integrated into the filter media.

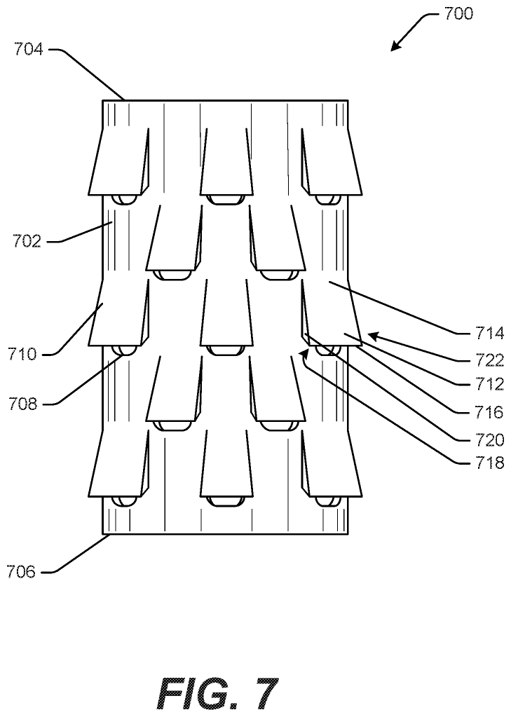

Additional modifications also are contemplated. For example, FIG. 7 illustrates an example outer sleeve 700 according to another implementation of this disclosure. The outer sleeve 700 may be used in place of the outer sleeve 110 and/or the outer sleeve 514 to alter flow of a fluid prior to the filter contacting a filter media. In the example, the outer sleeve 700 includes a generally cylindrical sidewall 702 extending, generally longitudinally, between a first open end 704 and a second open end 706. A plurality of holes 708 extend through the sidewall 702 and a plurality of protrusions 710 extend, e.g., radially outwardly, from the sidewall 702. In FIG. 7, each of the holes 708 corresponds to one of the protrusions 710, although in other examples more than one of the holes 708 may correspond to each of the protrusions 710.

Unlike other examples described herein, the protrusions 710 may not be formed as annular protrusions, or louvers, but instead as a plurality of discrete protrusions 710 along an outer surface of the sidewall 702. In the example, each of the protrusions 710 includes an angled surface 712 that general tapers outward from the sidewall 702 from a top edge 714 to a bottom edge 716. An end surface 718 (obscured in the drawing) may extend, e.g., as an undercut, from the bottom edge 716 to the sidewall 702. Accordingly, the angled surface 712 and the end surface 718 are angled relative to each other, e.g., to form a modified V-shape. In profile, each of the protrusions 710 may look substantially similar to the protrusion 122 shown in FIG. 2 and discussed above. The angles of the angled surface 712 and the end surface 720 relative to each other, and to other surfaces and/or references, e.g., relative to a plane normal to the longitudinal axis may vary. For example, the end surface 718 may be substantially normal to the longitudinal axis, like in the example of FIG. 5, in some implementations. As also shown in FIG. 7, the protrusion 710 may be bounded, e.g., laterally or circumferentially, by a first side 720 and a second side 722 spaced from the first side, e.g., by an angle, a distance, or otherwise. The sides 720, 722 may substantially parallel to each other and/or to the longitudinal axis of the sleeve 700, or the sides 720, 722, may be tapered or angled relative to each other.

The outer sleeve 700 may be configured to function in substantially the same way as the outer sleeve 110 and/or the outer sleeve 514. For example, the sleeve 700 may be configured to be placed around, or at least partially cover, a filter media. When contained in a filter element, fluid to be filtered may contact the outer sleeve 700 proximate the top end 704 and traverse, e.g., under the force of gravity or some external force, generally along the outer surface of the sidewall 702 from the top end 704 to the bottom end 706. However, as the fluid encounters the protrusions 710, the fluid will be directed at least partially radially outwardly, i.e., along the angled surface 712. As the fluid separates from the outer surface 712, e.g., at the bottom edge 716 of the outer surface 712, some of the fluid traverse around the second edge 716 and into the hole 708 immediately below the protrusion 710. As detailed above, by navigating this “turn” or “corner,” centrifugal force, gravity, and/or other forces may act on particulates in the fluid, causing those particulates to separate from the fluid. In this manner, fluid contacting the filter media (i.e., after passing through the holes 708 may be free of larger contaminants that can become lodged in or otherwise degrade functionality of the filter media.

### INDUSTRIAL APPLICABILITY

The present disclosure provides an improved filter assembly including an outer sleeve that may cause separation of particles from a fluid. The filter assembly may be used on a variety of applications. For example, the filter assembly may be used to filter fuel, gasoline, oil, lubricants, or the like. The filter assembly may be particularly useful in conjunction with engines to filter engine oil used by the engine for lubrication purposes. The disclosed filter assembly may result in better filtration of fluid, which may be more cost effective than previous designs and/or may reduce maintenance time and expense. For example, better filter fluids may lead to improved engine life and performance. Moreover, by removing larger contaminants from fluid prior to introducing the fluid to a filter media, the filter media may experience an increase in usable life.

According to some embodiments, a filter assembly 400, 500 may include an outer sleeve 110, 514, 700 with a plurality of external protrusions 122, 540, 710. The protrusions 122, 540, 710 may be configured to redirect fluid flow in the filter assembly 400, 500, in a way that forces act on contaminants in the fluid to remove those contaminants. Moreover, the contaminants may be retained in a channel 212, e.g., so as to be kept separate from the fluid. By removing contaminants in this manner, the filter assembly 400, 500 may improve engine performance and life.

While aspects of the present disclosure have been particularly shown and described with reference to the embodiments above, it will be understood by those skilled in the art that various additional embodiments may be contemplated by the modification of the disclosed assemblies, systems and methods without departing from the spirit and scope of what is disclosed. Such embodiments should be understood to fall within the scope of the present disclosure as determined based upon the claims and any equivalents thereof.

What is claimed is:

1. A filter element comprising:
an endcap;
filter media extending from the endcap in a longitudinal direction; and
a sleeve at least partly surrounding the filter media, the sleeve comprising:
a protrusion on an outer surface of the sleeve, the protrusion including an inclined surface angled relative to the longitudinal axis to direct fluid flowing along the protrusion away from the longitudinal axis; and
an opening extending through the sleeve, at least a portion of the opening being relatively closer to the endcap than at least a portion of the protrusion.

2. The filter element of claim 1, wherein the inclined surface extends from a first longitudinal end relatively farther from the endcap to a second longitudinal end relatively closer to the endcap in a longitudinal direction, the second longitudinal end being farther from the longitudinal axis than the first longitudinal end in a radial direction.

3. The filter element of claim 2, wherein the protrusion further comprises an end surface extending radially inward from the second longitudinal end of the inclined surface.

4. The filter element of claim 3, wherein the end surface extends between a first edge at the second longitudinal end of the inclined surface and a second edge at the outer surface of the sleeve, the first edge being offset in the longitudinal direction relative to the second edge.

5. The filter element of claim 1, wherein:
the outer surface is substantially cylindrical;
the protrusion comprises a circumferential ring disposed around the outer surface; and
the opening comprises a plurality of openings spaced circumferentially relative to each other.

6. The filter element of claim 1, wherein the protrusion comprises a plurality of protrusions arranged on the outer surface of the sleeve and the opening comprises a plurality of openings, individual of the plurality of protrusions being associated with at least two of the plurality of openings.

7. The filter element of claim 1, wherein:
the endcap has a top surface proximate the filter media; and
the endcap further includes a channel formed in the top surface.

8. The filter element of claim 7, wherein:
an outer diameter of the sleeve comprises a diameter about the longitudinal axis at the protrusion; and
at least a portion of the channel is disposed radially outwardly farther than the outer diameter of the sleeve.

9. The filter element of claim 1, further comprising:
an inner sleeve disposed in the volume, the inner sleeve including:
an outer surface facing an interior of the filter media;
an inner surface spaced from the outer surface by a thickness; and
a plurality of openings formed through the inner sleeve, the plurality of openings extending from the outer surface to the inner surface.

10. A filter assembly comprising:
an endcap;
filter media extending form the endcap in a longitudinal direction; and
a sleeve disposed at least partially surrounding the filter media, the sleeve comprising an outer surface including a plurality of protrusions and a plurality of openings, at least a portion of a first protrusion of the plurality of protrusions being disposed relatively farther from the endcap than a first opening of the plurality of openings to force fluid travelling generally along the outer surface in a direction toward the endcap radially outwardly from the first opening.

11. The filter assembly of claim 10, wherein the first protrusion includes:
an inclined surface angled relative to a longitudinal axis of the sleeve, the inclined surface extending from a first longitudinal end relatively farther from the endcap to a second longitudinal end relatively closer to the endcap in the longitudinal direction, the second longitudinal end being farther from the longitudinal axis than the first longitudinal end in a radial direction.

12. The filter assembly of claim 11, wherein the first protrusion further includes an end surface extending radially inward from the second longitudinal end of the inclined surface.

13. The filter assembly of claim 11, wherein:
the endcap has a top surface proximate the filter media; and
the endcap further includes a channel formed in the top surface, the channel being disposed to collect particulates separated from the fluid.

14. The filter assembly of claim 11, further comprising:
a housing defining an interior volume; and
an endplate, wherein:
the endplate is sealed relative to the housing such that the endcap, the filter media, and the sleeve are disposed at least partly in the interior volume,
the endplate further includes an inlet through which fluid enters the housing proximate the outer surface of the sleeve and travels in the direction, and
the endplate further includes an outlet in fluid communication with a cavity defined at least in part by the filter media.

15. The filter assembly of claim 14, further comprising an inner sleeve, the inner sleeve including:
an outer surface facing an interior of the filter media;
an inner surface spaced from the outer surface by a thickness and at least in part defining the cavity; and
a plurality of openings formed through the inner sleeve, the plurality of openings extending from the outer surface to the inner surface.

16. A filter assembly comprising:
a housing including a housing sidewall extending in a longitudinal direction between a closed end and an opposite, open end, the housing sidewall and the closed end defining an interior volume;
an endplate disposed in the open end and comprising at least one inlet and at least one outlet; and
a filter element at least partially disposed in the interior volume, the filter element comprising:
an endcap spaced from the endplate in the longitudinal direction;
an inner sleeve disposed between the endplate and the endcap, the inner sleeve including an inner sleeve sidewall defining a volume in fluid communication with the at least one outlet and having a plurality of holes through the sidewall;
filter media at least partially surrounding the inner sleeve; and
an outer sleeve at least partially surrounding the filter media, the outer sleeve comprising at least one protrusion and at least one opening, the outer sleeve being spaced from an inner surface of the housing sidewall and the inlet being in fluid communication with the space between the outer sleeve and the inner surface of the housing.

17. The filter assembly of claim 16, wherein fluid enters the space between the outer sleeve and the inner surface of the housing via the inlet and contacts the at least one protrusion, the at least one protrusion being configured to direct the fluid away from the filter media prior to the fluid passing through the at least one opening.

18. The filter assembly of claim 17, wherein:
the endcap has a top surface proximate the filter media; and
the endcap further includes a channel formed in the top surface.

19. The filter assembly of claim 18, wherein at least a portion of the channel is disposed radially outwardly relative to at least a portion of the at least one protrusion.

20. The filter assembly of claim 16, wherein the at least one protrusion comprises:
an inclined surface relatively closer to the filter media at a first longitudinal end relatively closer to the endplate and relatively farther from the filter media at a second longitudinal end relatively closer to the endcap; and
an end surface extending from the second longitudinal end of the inclined surface to the outer surface of the sleeve.
